(19) United States
(12) Patent Application Publication
(10) Pub. No.: US 2009/0293447 A1
(43) Pub. Date: Dec. 3, 2009

(54) Method for the provision of fire protection for titanium components of an aircraft gas turbine and titanium components for an aircraft gas turbine

(76) Inventors: Dan Roth-Fagaraseanu, Stahnsdorf (DE); Moritz Wirth, Berlin (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 12/385,713

(22) Filed: Apr. 16, 2009

(30) Foreign Application Priority Data
Apr. 16, 2008 (DE) DE102008019296.1

(51) Int. Cl. F02G 3/00; F01D 1/02

(52) U.S. Cl. 60/39.091; 415/200

(57) ABSTRACT

A method provides fire protection for titanium components of an aircraft gas turbine. To enable the use of titanium components on aircraft gas turbines without the risk of titanium fire, a surface-near, nonflammable, intermetallic phase of titanium and at least one further metal, selected from the group of aluminum, nickel, vanadium and chromium, including combinations thereof, is produced in the surface of the component by a diffusion process.

This application claims priority to German Patent Application DE102008019296.1 filed Apr. 16, 2008, the entirety of which is incorporated by reference herein.

This invention relates to a method for the provision of fire protection for titanium components of an aircraft gas turbine and to titanium components for an aircraft gas turbine made according to said method.

The safety requirements for aircraft gas turbines, in particular for the compressors thereof, require that titanium fire must be completely controllable within the gas turbine, in particular in the compressor. It has turned out however that titanium fire could not always be fully kept under control. Therefore, accidents due to titanium fire within aircraft gas turbines have occurred.

The material titanium is frequently used for the compressor casings of aircraft gas turbines. The major problem here is that titanium casings, despite the high melting point of titanium, were not capable of controlling all fire started by titanium rotor blades. A further significant problem is that, in the case of serious titanium fire, the casings themselves start burning, thereby promoting the propagation of the fire instead of containing it. In current designs of aircraft gas turbines, titanium is excluded from those areas in which the containment of titanium fire is mandatory.

Titanium fire has also occurred on aircraft gas turbines with split titanium casings and titanium rotor blades. The fire containment capability of these casings is improved by inserting segments made of steel. The steel segments provide for the actual fire protection. Alternatively, casings are used which are completely made of steel. The separate steel segments are, however, expensive to manufacture and impair the weight advantage of the titanium casing over modern all-steel casings. With all-steel casings, serious titanium fires have occurred on the titanium rotor blades. All these fires were however completely controllable within the compressor casings, so that this design can be considered as very safe with regard to titanium fire.

For protecting the casings in the event of a titanium fire, special protective coatings are used. These are:

Special protective coatings of titanium compounds having a certain degree of fire resistance. These have had extensive development. They are applied either to the titanium casing to fireproof the latter or to the titanium rotor blades to prevent titanium fire there.

Special protective coatings on the inside of the casings or on the inside of the abradable coatings in the casings. Zirconium oxide, in particular, is used for this purpose. However, the protective coatings must be relatively thick to be effective against serious titanium fire.

For example, a coating system for a rotor/stator sealing arrangement of a fluid-flow machine, in particular a gas turbine, is known from Specification WO 2005/071228 A1. The coating system is here applied to a component which preferably is made of a titanium-base alloy or a titanium-aluminum alloy. This coating system provides a thermal barrier coat with low thermal conductivity and high roughness. If the coating system is damaged or coating material spalls off, titanium fire may occur on the coated component. If the component itself is already very thin, such as a rotor blade or a stator vane, this type of coating system cannot be applied.

The conventional designs with steel casings are disadvantageous in that they feature a relatively high weight. While steel excels in its capability to contain fire, its high density means high weight. Steel also has a higher coefficient of thermal expansion than titanium. For casings, a very low thermal expansion is particularly advantageous.

Zirconium-oxide protective coatings are disadvantageous in that they are relatively hard, affecting application to complex structures of casings and stator vanes and rotor blades. Moreover, the protective coatings require a particular thickness to be effective and have a very rough surface finish. Protective coatings can be applied on the inside of a casing, but, for the above reasons, are not suitable for gas-wetted surfaces of blades or small, delicate structures of air offtake openings. Other disadvantages are the costs for the application of the protective coatings and the limited inspectability of components employing these coatings.

The present invention, in a broad aspect, describes a method for the provision of fire protection for titanium components and titanium components for an aircraft gas turbine made according to said method such that the titanium components can be used on aircraft gas turbines without the risk of titanium fire.

In accordance with the present invention, a solution to the above problems is provided by a surface-near, nonflammable, intermetallic phase of titanium and at least one further metal, selected from the group of aluminum, nickel, vanadium and chromium, including combinations thereof, produced in the surface of the component by a diffusion process. This enables components made of titanium, such as casing parts, stator vanes and rotor blades, to be used for aircraft gas turbines without the risk of titanium fire.

In an embodiment of the present invention, a layer of titanium-aluminide is produced in the surface of the titanium component by adding aluminum. In a diffusion process, the titanium-aluminide layer is produced in the surface of the titanium component either by vapor deposition of pure aluminum at temperatures above 650° C. or in an atmosphere of aluminum-oxide powder at temperatures above 900° C. The aluminum layer can also be electrolytically produced on the surface of the titanium component. Finally, the surface of the titanium component can be coated with a strongly aluminous paint and the aluminum subsequently transported into the surface of the titanium component in a diffusion process involving thermal treatment. Nickel, vanadium or other elements can also be added to the aluminum.

In a further embodiment of the present invention, a layer of a nickel-aluminum compound can be produced on the surface of the titanium component in a diffusion process involving the addition of nickel to the aluminum.

The present invention also relates to titanium components for an aircraft gas turbine provided with fire protection means, with an outer coat either in titanium-aluminide or in a nickel-titanium alloy being formed in the surface of the component.

The material titanium is used for gas turbines in aircraft manufacture because its low density provides a considerable weight saving over steel. Unlike nickel and steel which burn only at elevated temperatures, titanium fire can burn at temperatures above 1600° C. at an ambient pressure of 1 bar. The ignition temperature of titanium decreases with increasing pressure. If rotor blades made of titanium collide with casing components, the abrasive effect resulting therefrom may lead to sparking involving the risk of titanium fire. Such titanium fire on the rotor blades can easily propagate to static components, such as stator vanes and titanium casings.

The low thermal conductivity of titanium is a further disadvantage with stator vanes and rotor blades made of titanium. Crucial here is the ratio between the mass and the surface of the component. With the blade edges being thin and featuring low mass and the volume of the material being correspondingly small, the capacity of the titanium component to dissipate heat is bad.

In accordance with the present invention, it is therefore proposed to passivate the surface of a titanium component for an aircraft gas turbine, in particular within a compressor. In the process, a titanium-aluminide coat, for example, is produced on the surface of a titanium component by applying aluminum onto the component and diffusing the aluminum into the surface-near layer of the titanium component. Diffusion is accomplished at elevated temperatures in a furnace. The aluminum can be applied electrolytically, but any process for surface treatment of titanium with aluminum is suitable which permits subsequent diffusion in a furnace.

It has been found that titanium-aluminide, unlike unprotected titanium, will not burn spontaneously. Therefore, the risk of titanium fire or an error in fire fighting is reduced. Besides the diffusion of aluminum and the formation of a surface-near intermetallic phase of titanium and aluminum in the form of titanium-aluminide, other intermetallic phases which provide stable oxide coatings and protect the component against fire can be produced in the surface of a titanium component.

Also, a nickel-aluminum phase can be produced in the surface by application of nickel with aluminum and subsequent diffusion. The only disadvantage here is the high temperature for diffusing the nickel into the titanium, compared with the diffusion process of a pure aluminum coating of approx. 650° C.

The method according to the present invention can be applied to passivate rotor blades and stator vanes and other components made of titanium against titanium fire. A titanium rotor passivated in accordance with the present invention will not burn and, consequently, it will not be necessary to contain a titanium fire.

The method according to the present invention is particularly advantageous in that the passivation of a titanium component is independent of the shape of the latter. Thus, any titanium component for an aircraft gas turbine can be provided with a fire protection according to the present invention. The roughness of the component surface provided by the method according to the present invention is not higher than that of untreated, plain titanium. Production of the titanium-aluminide layer in an electrolytic process is inexpensively performable. The diffusion process can be performed in a simple heat treatment furnace.

Two different methods for the provision of fire protection for titanium components of an aircraft gas turbine are hereinafter described:

### 1. Application of an Aluminous Paint

A strongly aluminous paint, such as the paint known under the trade name Sacrificial paint SermeTel® WFX-2 by Sermatech® Int. Inc. USA, is used. The component to be treated is coated with the aluminous paint. Independently of the pre-treatment (painting, vapor deposition, electroplating), the diffusion process is carried out in a subsequent heat treatment operation in a heat treatment furnace at approx. 600 to 700° C. The organic constituents of the paint will burn off in the furnace. The aluminum diffuses into the surface of the component and forms a surface-near, nonflammable intermetallic phase of titanium and aluminum.

### 2. Vapor Deposition of Aluminum

Pure aluminum is vapor-deposited on the titanium component in a furnace. The aluminum melts at approx. 650° C., diffuses into the titanium and forms a diffusion layer of a surface-near, nonflammable intermetallic phase with the titanium.

For treating the titanium component, an atmosphere of aluminum oxide powder can also be produced in a furnace. The aluminum oxide melts only at approx. 900° C. and subsequently diffuses into the titanium.

In both vapor deposition processes, a gamma phase of a titanium aluminide is produced as intermetallic layer. Thus, an intermetallic phase is produced in the surface of the titanium component which, as it is nonflammable, protects the titanium component against titanium fire. Unlike a separately applied, special protective coating, the intermetallic layer cannot separate from the component.

Since the desired gamma phase of the titanium-aluminide embrittles easily, nickel, vanadium or other elements are added each to the aluminum to avoid brittleness.

What is claimed is:

1. A method for providing fire protection for a titanium component of an aircraft gas turbine, comprising:
producing in a surface of the component by a diffusion process a surface-near, nonflammable, intermetallic phase of titanium and at least one further metal, selected from the group of aluminum, nickel, vanadium and chromium, including combinations thereof.

2. The method of claim 1, wherein a layer of titanium-aluminide is produced in the surface of the titanium component by adding aluminum.

3. The method of claim 2, wherein the titanium-aluminide layer is produced in the surface of the titanium component in a diffusion process by vapor deposition of pure aluminum at temperatures above 650° C.

4. The method of claim 2, wherein the titanium-aluminide layer is produced in the surface of the titanium component in a diffusion process in an atmosphere of aluminum-oxide powder at temperatures above 900° C.

5. The method of claim 2, wherein an aluminum layer is electrolytically produced on the surface of the titanium component and subsequently transported into the surface in a diffusion process involving thermal treatment.

6. The method of claim 2, wherein the surface of the titanium component is coated with a strongly aluminous paint and subsequently the aluminum is transported into the surface of the titanium component in a diffusion process involving thermal treatment.

7. The method of claim 6, wherein at least one of nickel, vanadium and other elements are added to the aluminum.

8. The method of claim 1, wherein a layer of a nickel-titanium compound is produced in the surface of the titanium component in a diffusion process involving addition of nickel.

9. The method of claim 2, wherein at least one of nickel, vanadium and other elements are added to the aluminum.

10. The method of claim 3, wherein at least one of nickel, vanadium and other elements are added to the aluminum.

11. The method of claim 4, wherein at least one of nickel, vanadium and other elements are added to the aluminum.

12. The method of claim 5, wherein at least one of nickel, vanadium and other elements are added to the aluminum.

13. A titanium component for an aircraft gas turbine, having fire protection comprising an outer coat of titanium-aluminide in a surface of the titanium component.

14. A titanium component for an aircraft gas turbine having fire protection comprising an outer coat of a nickel-titanium compound in a surface of the titanium component.
